(19) United States
(12) Patent Application Publication
(10) Pub. No.: US 2019/0195307 A1
(43) Pub. Date: Jun. 27, 2019

(54) Frequency-Dependent Damping Valve Assembly And Vibration Damper

(71) Applicant: ZF FRIEDRICHSHAFEN AG, Friedrichshafen (DE)

(72) Inventor: Andreas FÖRSTER, Schweinfurt (DE)

(21) Appl. No.: 16/331,461

(22) PCT Filed: Aug. 3, 2017
(86) PCT No.: PCT/EP2017/069589

§ 371 Date: Mar. 7, 2019

(30) Foreign Application Priority Data
Sep. 8, 2016 (DE) 10 2016 217 113.5

(51) Int. Cl. F16F 9/348; F16F 9/512

(52) U.S. Cl. CPC F16F 9/3485; F16F 9/512; F16F 9/3488

(57) ABSTRACT

A frequency-dependent damping valve arrangement of a vibration damper having a damping piston with a check valve arranged inside of a cylinder. The damping piston is fastened to a carrier; a control arrangement arranged at the carrier includes a control pot, a control piston arranged in the control pot and slidingly axially displaceable at the carrier; and a spring arrangement arranged so as to be slidingly axially displaceable between the damping piston and the control piston at the carrier. The spring arrangement includes a first and a second disk-shaped spring element and at least one separating element arranged between the spring elements and which is slidingly axially displaceable at the carrier surface. The spring elements axially contact the separating element by their radially central portion and axially contact the damping piston and/or the control piston at least indirectly by their radial edge portion.

### CROSS REFERENCE TO RELATED APPLICATIONS

This is a U.S. national stage of application No. PCT/EP2017/069589, filed on Aug. 3, 2017. Priority is claimed on German Application No. DE102016217113.5, filed Sep. 8, 2016, the content of which is incorporated herein by reference.

### BACKGROUND OF THE INVENTION

### 1. Field of the Invention

The invention is directed to a damping valve arrangement of a vibration damper for a motor vehicle with a frequency-dependent damping force characteristic.

### 2. Description of the Prior Art

The object of a vibration damper in a motor vehicle is to damp the vibrations excited by an uneven road surface. In doing so, it is always necessary to find a compromise between driving safety and driving comfort. A vibration damper having a damping valve arrangement adjusted to be hard and has a high damping force characteristic is optimal for highly safe driving. If there is a high demand for comfort to be met, the damping valve arrangement should be adjusted to be as soft as possible. It is very difficult to find this compromise in a vibration damper with a conventional damping valve arrangement which is not adjustable electronically by an actuator.

A generic damping valve arrangement with a frequency-dependent damping force characteristic is known from DE 10 2014 210 704. This damping valve arrangement comprises a check valve arranged inside a cylinder filled with a damping medium and which has at least one flow channel covered by a plurality of valve disks. The damping valve arrangement further comprises a control arrangement arranged coaxial to the check valve and which comprises a control pot with an axially displaceable control piston arranged in the control pot. The control piston axially limits a control space enclosed in the control pot and connected to the damping valve arrangement via an inlet connection. A spring arrangement is arranged between the control piston and the damping valve and axially introduces a spring force into the control piston on the one hand and into the damping valve on the other hand. When the control space is filled with damping medium, the control piston displaces in direction of the damping valve and, via the spring element, increases the pressing pressure of the valve disks of the damping valve, which increases the damping force. The spring arrangement comprises a plurality of plate spring-shaped spring elements arranged such that they are stacked with their central openings against one another, and the radial outer ends of the spring elements come in contact at least indirectly with the control piston or with the damping valve, respectively.

In damping arrangements of this type, it is very important that the individual component parts of the spring arrangement are centered very accurately relative to one another. If this is not ensured, a tilting of individual component parts and a clamping of the spring arrangement under load cannot be ruled out. Because of the manufacturing tolerances, however, the current requirement for accurate centering of the spring arrangement component parts can only be met with great difficulty and with the use of expensive additional machining processes.

### SUMMARY OF THE INVENTION

It is the object of one aspect of the present invention to provide an alternative frequency-selective damping valve arrangement with a spring arrangement that avoids the risk of tilting of the component parts of the spring arrangement and prevents a clamping of the spring arrangement under load condition.

According to one aspect of the present invention the spring arrangement comprises at least a first disk-shaped spring element and a second disk-shaped spring element and at least one separating element arranged between the spring elements that is slidingly axially displaceable at the carrier surface, wherein the spring elements axially contact the separating element by their disk center and axially contact the damping piston and/or the control piston at least indirectly by their disk edge.

According to a further advantageous constructional variant, it is provided that the surface of the separating element facing the carrier has a sliding portion and at least a first clearance portion and a second clearance portion arranged, respectively, axially adjoining a side of the sliding portion, wherein the clearance portions in each instance radially limit a free space between the carrier and the separating element. The clearance portions help to prevent a clamping of the sliding element at the carrier in case of possible tilting of the separating element with respect to the longitudinal axis of the carrier.

In a very simple advantageous embodiment form, a clearance portion can be realized in a very simple manner, for example, by recessing the axial end portion of the separating element so that the latter is formed such that its free space forms an angle between the carrier and the separating element, wherein the angle tip is directed toward the sliding portion.

It is provided in an advantageous manner that the separating element can be constructed annularly as an open, i.e., slit, ring or as a closed ring. In this regard, the separating element can have any cross-sectional shape which meets the set requirements. In the simplest case, the separating element can have a circular cross section.

The separating element can be made from a metal or a plastic, with or without fiber reinforcement, which is suitable to transfer force from one spring element to the other spring element without deforming.

Advantageously, it can be provided that the separating element is constructed in such a way that the disk edge of the first spring element and the disk edge of the second spring element do not touch one another even under a maximum load of the spring arrangement so that the spring rate can be utilized to the maximum extent. In the simplest case, this effect can be achieved through the selection of the length of the axial extension of the separating element.

### BRIEF DESCRIPTION OF THE DRAWINGS

The invention will now be described in more detail referring to the figures.

The drawings show:

FIG. 1 is a sectional view of an exemplary constructional variant of a frequency-dependent damping valve arrangement according to the invention in a cylinder of a vibration damper; and

FIG. 2 is a partial sectional view of an exemplary constructional variant of a spring arrangement according to the invention.

### DETAILED DESCRIPTION OF THE PRESENTLY PREFERRED EMBODIMENTS

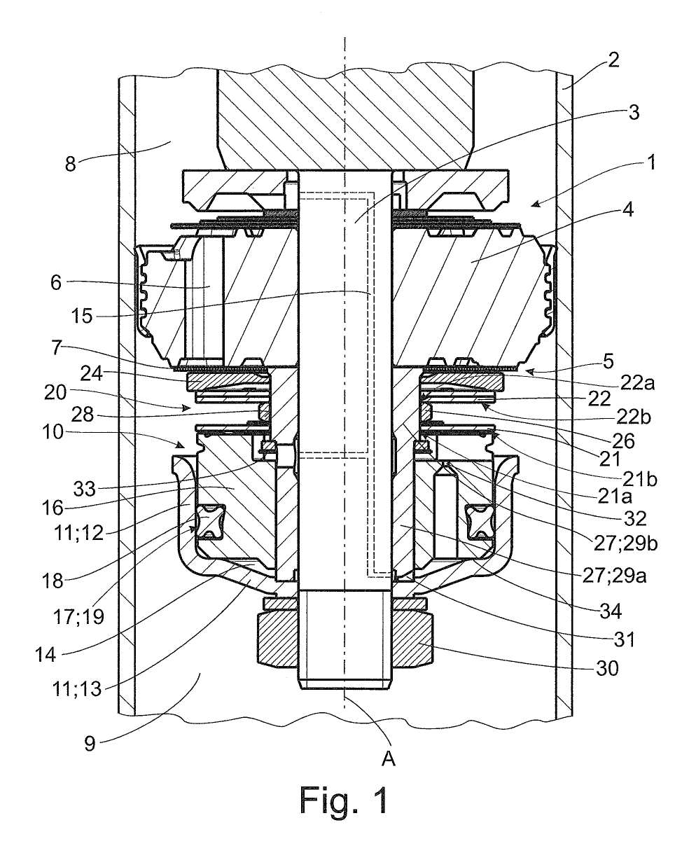

FIG. 1 shows a portion of a vibration damper for a motor vehicle with a frequency-dependent damping valve arrangement 1 according to one aspect of the invention in a sectional view.

The latter comprises a cylinder 2 which is at least partially filled with a damping fluid.

Damping valve arrangement 1 is fastened to an axially displaceable piston rod 3 inside the cylinder 2. Damping valve arrangement 1 comprises a damping piston 4 with at least one check valve 5, this check valve 5 having at least a first flow channel 6 formed therein for the damping fluid, which flow channel 6 is covered by at least one valve disk 7.

Damping piston 4 divides a first working chamber 8 from a second working chamber 9 inside cylinder 2 such that the ratio of the damping medium pressure in the two working chambers 8, 9 varies depending on the direction of axial movements of damping piston 4 in cylinder 2.

Further, damping valve arrangement 1 has a control arrangement 10 that contains a control pot 11 with a cylindrical pot wall 12 and a disk-shaped pot base 13 and with a control piston 16 that is axially displaceably arranged in control pot 11 and axially limits a control space 14 enclosed in control pot 11.

A spring arrangement 20 is arranged between damping piston 4 and control arrangement 1 and impinges with a defined spring force on valve disk 7 axially in direction of first flow channel 6 and on control piston 16 in direction of pot base 13.

All of the structural component parts of damping valve arrangement 1 are arranged coaxial to one another at piston rod 3. As shown in FIG. 1, damping valve arrangement 1 can comprise an additional guide sleeve 29 arranged so as to be threaded onto the piston rod and functions as a carrier 27 within the meaning of the invention. It is provided in the constructional variant shown in FIG. 1 that the piston rod 3 extends centrally through damping piston 4 and a guide sleeve 29 functioning as a carrier 27, which guide sleeve 29 in turn likewise extends centrally through spring arrangement 20 and control piston 16. Guide sleeve 29 comprises a first guide portion 29a and a second guide portion 29b axially adjacent thereto. Control piston 16 can slide axially along first guide portion 29a, and spring arrangement 20 can slide axially along second guide portion 29b. The direction of the axial movements of control piston 16 depends on the damping medium pressure in control space 14.

It is provided in the constructional variant shown in FIG. 1 that the damping valve arrangement 1 comprises at least a second flow channel 15 formed at and/or in piston rod 3 and which connects the first working chamber 8 and/or second working chamber 9 with the control space 14.

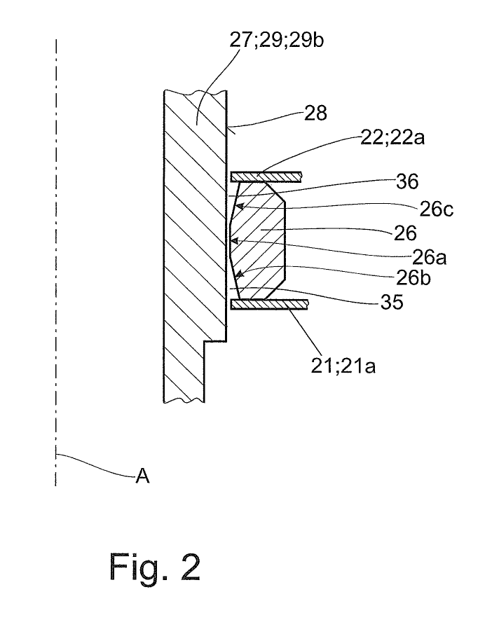

Control pot 11 of control arrangement 1 is connected to the piston rod in the area of pot base 13 with the aid of connection element 30. Connection element 30 shown in FIGS. 1 and 2 is a threaded nut. It will be appreciated that connection element 30 can also have a different suitable constructional form. In general, the connection between the piston rod and/or guide sleeve 29 and control pot 11 can be carried out by bonding engagement and/or positive engagement and/or frictional engagement.

Control piston 16 arranged inside control pot 11 is constructed so as to be axially displaceable so that when a damping fluid pressure persists over a longer period of time in control space 14 of control arrangement 1 the control piston 16 is displaced in direction of valve disk 7 of check valve 5 and tightens spring arrangement 20 so that the spring force acting on valve disk 7 through spring arrangement 20 and, therefore, the damping force of check valve 5 are increased.

As is shown in FIG. 1, control piston 16 has a seal arrangement 17 that seals control piston 16 relative to pot wall 12. This seal arrangement 17 comprises a circumferential groove 19 formed at control piston 16 and has a seal ring 18 arranged therein.

Second flow channel 15 comprises an inlet restrictor 31, which defines the flow of damping medium out of first working chamber 8 into control space 14.

Further, an outlet restrictor 32 is formed at control piston 16 and influences the flow of damping medium out of control chamber 14. This outlet restrictor 32 can also be formed at carrier 3.

A first stop 33 and second stop 34 are formed at control arrangement 1 for defining the soft damping characteristic and hard damping characteristic. First stop 33 is formed as a stop ring in the constructional variants shown in FIG. 1, and second stop 34 is formed as an at least partial ridge of pot base 13. It will be appreciated that second stop 34 can also be formed as a stop ring or as an additional stop element which can be arranged inside of control space 14.

Spring arrangement 20 can be constructed in a variety of ways. In the constructional variant shown in FIG. 1, it is provided that spring arrangement 20 comprises a plurality of spring elements 21, 22 separated from one another by a separating element 26. Spring elements 21, 22 and separating element 26 surround guide sleeve 29 and are arranged coaxial to the rest of the structural component parts of damping valve arrangement 1. First spring element 21 is axially supported at control piston 16 on one side and at separating element 26 on the other side. Further spring elements are axially supported at least indirectly at separating element 26 on the one side and at valve disk 7 via a spacer ring 24 on the other side.

During a high-frequency excitation of the vibration damper, the damping fluid pressure persists only briefly in control space 14, whereas the damping fluid pressure persists significantly longer in control space 14 during a low-frequency excitation of the vibration damper.

The control arrangement 10 of damping valve arrangement 1 is constructed such that when a damping fluid pressure persists over a longer period of time in control space 14 of control arrangement 10 the control piston 16 is displaced in direction of valve disk 7 of check valve 5 and tightens spring arrangement 20 so that the spring force acting on valve disk 7 through spring arrangement 20 and, therefore, the damping force of check valve 5 are increased.

As has already been mentioned, spring arrangement 20 comprises at least a first disk-shaped spring element 21 and a second disk-shaped spring element 22 and a separating element 26 arranged between spring elements 21, 22 and slidingly axially displaceable at the carrier surface 28. Spring elements 21, 22 axially contact separating element 26 by their radially central portion 21a, 22a and at least indirectly axially contact damping piston 4 on one side and control piston 16 on the other side by their radial portion 21b, 22b.

FIG. 2 shows particularly clearly that the surface of separating element 26 facing carrier 27 is divided into three portions. These three portions comprise a sliding portion 26a, a first clearance portion 26b, and a second clearance portion 26c which are arranged, respectively, axially adjoining a side of the sliding portion 26a. The clearance portions 26b, 26c in each instance radially limit a free space 35, 36 between carrier 27 and separating element 26.

According to the constructional variant shown in FIG. 2, clearance portions 26b, 26c are constructed such that free space 35, 36 in each instance forms an angle between carrier 27 and separating element 26, and the angle tip is directed toward the sliding portion 26a. It will be appreciated that the free spaces 35, 36 can also have other suitable cross-sectional shapes.

According to FIGS. 1 and 2, separating element 26 can be constructed annularly as a closed ring or as an open ring, i.e., slit ring, in the same way as at least one free space 35, 36 can be formed annularly.

Further, separating element 26 can be made from a metal or a suitable plastic, with or without fiber reinforcement.

In the constructional variants according to FIGS. 1 and 2, the length of the axial extension of separating element 26 has been selected such that the radial edge portion 21b of the first spring element 21 and the radial edge portion 22b of the second spring element 22 do not touch one another even under maximum loading of spring arrangement 20.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-10. (canceled)

11. A frequency-dependent damping valve arrangement of a vibration damper for a motor vehicle, comprising:
a cylinder that is at least partially filled with a damping fluid;
a check valve;
a carrier;
a damping piston with the check valve, which damping piston is arranged inside of the cylinder and the damping piston is fastened to the carrier;
a control arrangement arranged at the carrier coaxial to the damping piston that comprises:
a control pot; and
a control piston arranged in the control pot and slidingly axially displaceable at the carrier;
a spring arrangement arranged to be slidingly axially displaceable between the damping piston and the control piston at the carrier and comprising:
at least a substantially disk-shaped first spring element;
a substantially disk-shaped second spring element; and
at least one separating element arranged between the first spring element and the second spring element and which is slidingly axially displaceable at a carrier surface,
wherein the first spring element and the second spring element axially contact the separating element by their respective radially central portion and axially contact the damping piston and/or the control piston at least indirectly by their radial edge portion.

12. The frequency-dependent damping valve arrangement according to claim 11, wherein a surface of the separating element facing the carrier has a sliding portion and at least a first clearance portion and a second clearance portion that are arranged, respectively, axially adjoining a side of the sliding portion, wherein the first and second clearance portions in each instance radially limit a free space between the carrier and the separating element.

13. The frequency-dependent damping valve arrangement according to claim 12, wherein at least one of the first and second clearance portions is formed such that the free space forms an angle between the carrier and the separating element, wherein an angle tip is directed toward the sliding portion.

14. The frequency-dependent damping valve arrangement according to claim 11, wherein the separating element is constructed annularly.

15. The frequency-dependent damping valve arrangement according to claim 12, wherein the free space is constructed annularly.

16. The frequency-dependent damping valve arrangement according to claim 11, wherein the separating element is made of a metal.

17. The frequency-dependent damping valve arrangement according to claim 11, wherein the separating element is made of a plastic with or without fiber reinforcement.

18. The frequency-dependent damping valve arrangement according to claim 11, wherein the separating element is constructed as an open slit ring.

19. The frequency-dependent damping valve arrangement according to claim 11, wherein a length of an axial extension of the separating element is selected such that the radial edge portion of the first spring element and the radial edge portion of the second spring element do not touch one another, even under a maximum load of the spring arrangement.

20. A vibration damper with a frequency-dependent damping valve arrangement, wherein the frequency-dependent damping valve arrangement comprises:
a cylinder that is at least partially filled with a damping fluid;
a check valve;
a carrier;
a damping piston with the check valve, which damping piston is arranged inside of the cylinder and the damping piston is fastened to the carrier;
a control arrangement arranged at the carrier coaxial to the damping piston that comprises:
a control pot; and
a control piston arranged in the control pot and slidingly axially displaceable at the carrier;
a spring arrangement arranged to be slidingly axially displaceable between the damping piston and the control piston at the carrier and comprising:
at least a substantially disk-shaped first spring element;
a substantially disk-shaped second spring element; and
at least one separating element arranged between the first spring element and the second spring element and which is slidingly axially displaceable at a carrier surface,
wherein the first spring element and the second spring element axially contact the separating element by their respective radially central portion and axially contact the damping piston and/or the control piston at least indirectly by their radial edge portion.
